(19) United States
(12) Patent Application Publication
(10) Pub. No.: US 2005/0128063 A1
(43) Pub. Date: Jun. 16, 2005

(54) Vehicle driving assisting apparatus

(75) Inventors: Kazuyoshi Isaji, Kariya-city (JP); Naohiko Tsuru, Handa-city (JP); Takahiro Wada, Takamatsu-city (JP); Hiroshi Kaneko, Okayama-city (JP)

Correspondence Address: POSZ LAW GROUP, PLC, 12040 SOUTH LAKES DRIVE, SUITE 101, RESTON, VA, 20191, US

(73) Assignee: DENSO CORPORATION

(21) Appl. No.: 10/974,679

(22) Filed: Oct. 28, 2004

(30) Foreign Application Priority Data
Nov. 28, 2003 (JP) 2003-400187
Dec. 17, 2003 (JP) 2003-420008
Jan. 13, 2004 (JP) 2004-6008

(51) Int. Cl. B60Q 1/00

(52) U.S. Cl. 340/439; 340/435; 701/70; 701/36; 340/576

(57) ABSTRACT

A vehicle driving assisting apparatus determines whether a driver is executing a driving operation for stopping a vehicle when a distance up to a halting vehicle exiting in front of the vehicle is shorter than a distance obtained by adding a margin to an estimated braking distance for stopping the vehicle by starting a normal deceleration operation from the present vehicle speed. When the driving operation for stopping the vehicle has not been executed, an alarm is generated for causing the driver's attention in the forward direction. This makes it possible to properly determine the driver's degree of recognition of the traffic environment in front of the vehicle.

### CROSS REFERENCE TO RELATED APPLICATION

This application is based on and incorporates herein by reference Japanese Patent Applications No. 2003-400187 filed on Nov. 28, 2003, No. 2003-420008 filed on Dec. 17, 2003 and NO. 2004-6008 filed on Jan. 13, 2004.

### FIELD OF THE INVENTION

The present invention relates to a vehicle driving assisting apparatus.

An apparatus is proposed for providing information related to obstacles depending upon the driver's degree of recognition of the obstacles (JP-A-2001-357498). According to this apparatus for providing information, for example, a gazing point of the driver who is driving the vehicle is detected by a gazing point sensor. When a positional relationship of the vehicle to the obstacle existing ahead is detected by a front obstacle sensor, the mode of providing information related to the obstacle is varied depending upon whether the obstacle exists at a position in the range of visual field that is set based on the gazing point that is detected.

This apparatus for providing information simply provides information depending upon the degree of recognition of the obstacle existing ahead. It cannot offer information depending upon the degree of recognition of surrounding traffic environment which is necessary for driving the vehicle.

Further, when the vehicle travels following a preceding vehicle that is traveling ahead, the driver of the vehicle drives the vehicle paying attention to the preceding vehicle so will not to collide the preceding car from behind. In such a case, safety traveling can be maintained if the driver pays attention to the preceding car. Therefore, the driver feels it bother if information is provided concerning the obstacles other than the preceding vehicle.

There has further been proposed a display apparatus for a vehicle for letting the driver know the presence of a signal and a stop sign ahead (JP-A-2000-331289). This display apparatus for vehicle makes it possible to obtain information while, for example, a cell phone is being used, and provides the driver with information for assisting the driving when there is obtained drive assisting information such as a traffic signal or a stop sign within a predetermined distance in a direction in which the vehicle is traveling.

This display apparatus for a vehicle works to decrease the driver's overlooking of signals or stop signs that may result from a careless attention of the driver in a direction in which he is traveling when he is using a cell phone or when he is obsessed by the driving operation. Despite the driver is paying attention in the forward direction in which he is traveling, he may still overlook the objects that must not be overlooked for the driving if object such as the signal or the stop sign that is necessary for the driving is not included in the object to which he is giving attention.

### SUMMARY OF THE INVENTION

It is a first object of the present invention to provide a vehicle driving assisting apparatus, which is capable of properly determining the driver's degree of recognition of the traffic environment in front of the vehicle and of assisting the driving based on the determination result.

It is a second object of the present invention to provide a vehicle driving assisting apparatus which does not provide the driver of the vehicle with bothersome information.

It is a third object of the present invention to provide a vehicle driving assisting apparatus, which is capable of properly determining the driver's degree of recognition of the objects necessary for the driving.

For attaining the first object, a vehicle driving assisting apparatus determines whether a distance up to a stopping point is shorter than a predetermined distance, and determines whether a vehicle driver is executing a driving operation for stopping the vehicle short of the stopping point based on an actual driving condition of the driver thereby to determine a driver's degree of recognition of traffic environment in front of the vehicle. The actual driving condition to be considered may be a vehicle decelerating operation by the driver, a level of deceleration of the vehicle, a pattern of deceleration of the vehicle, or the like.

For attaining the second object, a vehicle driving assisting apparatus generates an alarm to cause driver's attention to a body in front of a vehicle when a driving operation has not been executed for stopping the vehicle, but do not generate the alarm when the distance up to the body is shorter than a predetermined distance and the amount of distance change or speed change is smaller than a predetermined distance or speed change despite that the driving operation has not been executed for stopping the vehicle.

For attaining the third object, a vehicle driving assisting apparatus determines whether a relation of a distance between a vehicle and a road facility satisfies a predetermined condition, detects the position of the road facility in a front image pictured by an imaging camera, detects a gazing point of a driver of the vehicle, sets on the image a central viewing area based on the detected gazing point, and determines a driver's degree of recognizing the road facility depending upon whether the road facility is in the central viewing area on the image.

### BRIEF DESCRIPTION OF THE DRAWINGS

The above and other objects, features and advantages of the present invention will become more apparent from the following detailed description made with reference to the accompanying drawings. In the drawings:

FIG. 1 is a block diagram illustrating a vehicle driving assisting apparatus according to a first embodiment of the invention;

FIG. 2 is a control block diagram of a computer according to the first embodiment;

FIG. 3 is an image of an estimated braking distance when a driver operates the vehicle VS at a point Pa to stop the vehicle at a point Ps short of the halting vehicle VL according to the first embodiment;

FIG. 4 is a flowchart according to the first embodiment;

FIG. 5 is a flowchart illustrating the flow of an alarm generation processing according to a first modification of the first embodiment;

FIG. 6 is a flowchart illustrating the flow of an alarm generation processing according to a second modification of the first embodiment;

FIG. 7 is a control block diagram of a computer according a third modification of the first embodiment;

FIG. 8 is a flowchart illustrating the flow of an alarm generation processing according to the third modification of the first embodiment;

FIG. 9 is a control block diagram of a computer according to a second embodiment of the present invention;

FIG. 10 is an image illustrating an estimated stopping distance calculated from an idle running distance and an estimated braking distance according to the second embodiment;

FIG. 11 is a table setting standard patterns of the driving operation depending upon the distances up to the target points of stop according to the second embodiment;

FIG. 12 is a flowchart illustrating the flow of an alarm generation processing according to the second embodiment;

FIG. 13 is a block diagram illustrating a vehicle driving assisting apparatus according to a third embodiment of the invention;

FIG. 14 is a control block diagram of a computer according to the third embodiment;

FIG. 15 is a flowchart illustrating the flow of an alarm generation processing according to the third embodiment;

FIG. 16 is a control block diagram of the computer according to a modification of the third embodiment;

FIG. 17 is a control block diagram of the computer constituting the vehicle driving assisting apparatus according to a fourth embodiment of the present invention;

FIG. 18 is a flowchart illustrating the flow of an alarm generation processing according to the fourth embodiment;

FIG. 19 is a block diagram illustrating the whole constitution of the vehicle driving assisting apparatus according to a fifth embodiment of the invention;

FIG. 20 is a control block diagram of the computer according to the fifth embodiment of the invention;

FIG. 21 is a view of an image including road facilities such as a traffic signal, a stop sign and a speed-limit sign installed along the road in front of the vehicle;

FIG. 22 is a view setting a central viewing area on the image imaged by a viewing camera;

FIG. 23 is a flowchart illustrating the flow of an alarm generation processing by the vehicle driving assisting apparatus according to the fifth embodiment of the invention;

FIG. 24 is a view illustrating a length L up to a signal located outside the central view area ca according to a first modification of the fifth embodiment; and

FIG. 25 is a control block diagram of the computer according to a second modification of the fifth embodiment.

### DETAILED DESCRIPTION OF THE PREFERRED EMBODIMENT

A vehicle driving assisting apparatus according to the invention will now be described with reference to various embodiments shown in the drawings.

### First Embodiment

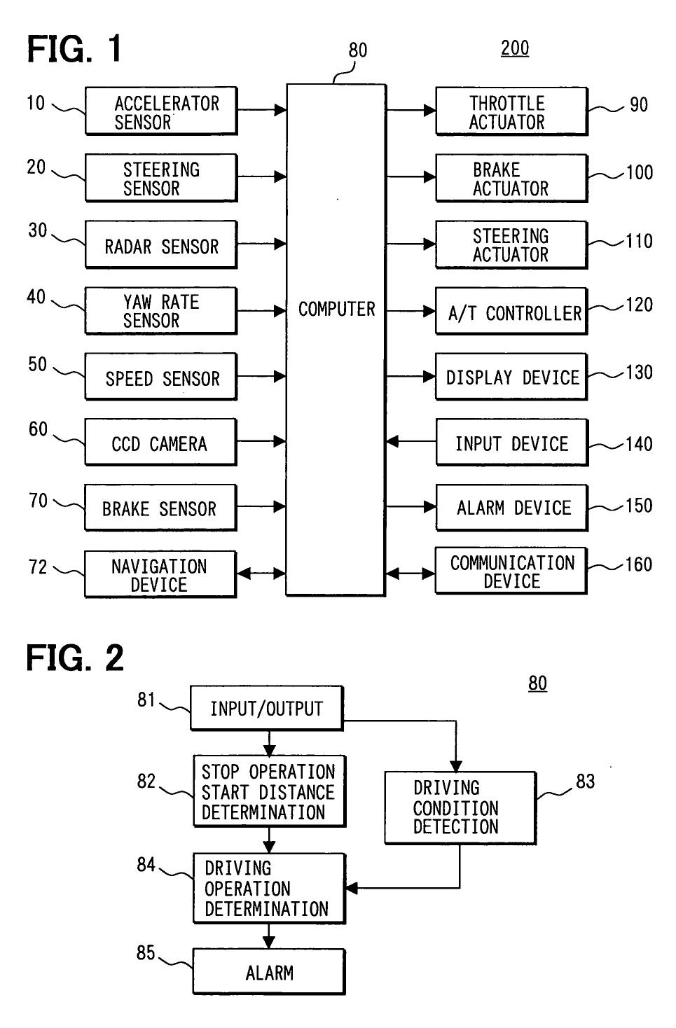

Referring to FIG. 1, a vehicle driving assisting apparatus 200 includes an accelerator sensor 10, a steering sensor 20, a laser radar sensor 30, a yaw rate sensor 40, a vehicle speed sensor 50, a CCD camera 60, a brake sensor 70 and a navigation device 72, which are connected to a computer 80.

The driving assisting apparatus 200 further includes a throttle actuator 90, a brake actuator 100, a steering actuator 110, an automatic transmission controller 120, a display device 130, an input device 140, an alarm device 150 and a communication device 160, which are connected to the computer 80.

The computer 80 is provided with an input/output interface I/O and various drive circuits that are not shown. When an obstacle such as other vehicle is detected in front of the vehicle, the computer 80 determines the driver's degree of recognition of the obstacle, generates an alarm when it is so determined that the driver is not recognizing the obstacle, and executes alarm generation processing to cause the driver's attention to the forward direction of the vehicle.

Based upon information from various sensors, further, the computer 80 drives the throttle actuator 90, brake actuator 100, steering actuator 110, and automatic transmission controller 120, to execute travel control processing such as a lane-keeping travel control for driving the vehicle maintaining the traveling lane and a distance-between-cars (distance to the preceding car) control for driving the vehicle maintaining a suitable time relative to the preceding vehicle.

The accelerator sensor 10 detects the accelerator pedal operation (on/off) by the driver. The accelerator pedal operation signal that is detected is sent to the computer 80. The steering sensor 20 detects the amount of change in the steering angle of the steering wheel, and a relative steering angle is detected from a value thereof.

The laser radar sensor 30 projects a laser beam over a predetermined range in front of the vehicle, and detects a distance Lobs to a reflecting body such as a vehicle ahead that is reflecting the laser beam, a speed relative thereto, and an azimuth of the reflecting body to the vehicle. The body information including the detected results is converted into electric signals and are output to the computer 80. The laser radar sensor 30 detects the object by using a laser beam. However, the bodies surrounding the vehicles may be detected by using electromagnetic waves and ultrasonic waves, such as millimeter waves and microwaves.

The yaw rate sensor 40 detects the angular velocity of the vehicle about the vertical axis. The vehicle speed sensor 50 detects the signals corresponding to the rotational speed of the wheel. The CCD camera 60 is an optical camera used for imaging a predetermined range in front of the vehicle, and converts the image into the electric signals which are, then, output to the computer 80.

The brake sensor 70 detects the on/off of the brake pedal operation by the driver. The brake pedal operation signal that is detected is sent to the computer 80.

As is well known, the navigation device 72 detects the present position of the vehicle, and executes various functions such as a map display function for displaying a map of the vicinity of the vehicle, a neighboring facility-searching function for searching the facilities in the vicinity, and a route guide function for guiding the route to the destination.

The navigation device 72 is equipped with a position detector, a map data input device, and a VICS receiver which are not shown. Among them, the position detector is furnished with a terrestrial magnetism sensor, a gyroscope, a distance sensor, and a GPS receiver for the GPS (global positioning system) for detecting the position of the vehicle based on the electromagnetic waves from a satellite, which are well known. They contain errors due to their specific natures. Therefore, the signals may be used being compensated by a plurality of sensors. Depending upon the precision of the sensors, the position detector may be constructed by some of those described above.

A map data input device is an apparatus for inputting the map data. A medium for storing the map data may be a CD-ROM or a DVD-ROM. However, a writable memory medium such as a memory card or a hard disk may be used.

The map data is constructed chiefly by link data and node data. Here, the links in the link data are such that the roads on a map are divided by a plurality of nodes such as the intersecting points, branching points and meeting points, and the nodes are connected by the links. A road is constructed by connecting the links. The link data are constructed by a specific number (link ID) specifying the link, a link length representing the length of the link, start and end node coordinates (longitude, latitude) of the link, name of the road, and a width of the road.

Further, the node data are constructed by node ID attaching a specific number to every node where the roads on the map are intersecting, meeting or branching, by the node coordinate, node name, connection link ID describing link IDs of all links connected to the nodes, kind of the intersecting point, signal data such as the presence and kind of the signal, regulation information such as stop here, position of the railroad crossing, etc.

The VICS receiver receives road traffic information delivered from the VICS (vehicle information and communication system) center via beacons along the side of the road and FM broadcast stations. The road traffic information include jamming information such as jamming section and degree of jamming, traffic regulation information such as no passage, and signal information such as the position (coordinate) where the signal is installed in front on the road and the present signal indication (red/yellow/green/green arrow, etc.) of the signal.

In response to the computer 80, the navigation device 72 calculates distances from the present position of the vehicle up to a pedestrian crossing or an intersection where the vehicle must stop, up to a stop point (position of the stop line) at the intersection where the signal is installed, a stop point (position of the stop line) at the railroad crossing, and up to atoll gate installed on the toll road. The signal information from the VICS receiver and the information of stop point constructed by the information of the calculated distance are transmitted to the computer 80.

The throttle actuator 90, brake actuator 100, steering actuator 110 and automatic transmission controller 120 are all driven according to the instructions from the computer 80. The throttle actuator 90 adjusts the opening degree of a throttle valve to control the output of the internal combustion engine. The brake actuator 100 adjusts the braking pressure, and the steering actuator 110 causes a steering to produce a rotational toque thereby to drive the steering. The automatic transmission controller 120 selects the gear position of an automatic transmission which is necessary for controlling the speed of the vehicle.

The display device 130 is constructed by, for example, a liquid crystal display, and is installed near the center console in the compartment. The display device 130 receives the image data of map display from the navigation device 72, and the image data of alarm display from the computer 80 for causing the driver's attention to the forward direction of the vehicle. The display apparatus 130 displays the image corresponding to the image data.

The input device 140 is, for example, a touch switch or a mechanical switch integral with the display device 130, and is used for inputting various inputs such as characters. The alarm device 150 is for generating an alarm sound for causing the driver's attention, and produces an alarm as instructed by the computer 80.

In the lane-keeping travel control, for example, an alarm is produced when the vehicle is likely to deviate from the travel lane. In the distance-between-cars control, the alarm is produced when the vehicle quickly approaches the preceding vehicle exceeding the limit of the distance-between-cars control.

The communication device 160 is a mobile communication device for connection to an external network such as an internet. The latest map data used in the navigation device 72 can be obtained from the communication device 160 through the external network. The mobile communication device may be, for example, a cell phone, a mobile PC (personal computer) having a communication function, or a PDA (personal digital assistants). Further, the navigation device 72 incorporating the communication function may be used.

Next, FIG. 2 is a control block diagram of the computer 80. Referring to FIG. 2, the control processing of the computer 80 is functionally divided into the blocks of an input/output device 81, a stop operation start distance determining device 82, a driving condition detecting device 83, a driving operation determining device 84 and an alarm generating device 85. The input/output device 81 receives the signals from various sensors, and produces signals that are to be output after having been processed by the computer 80.

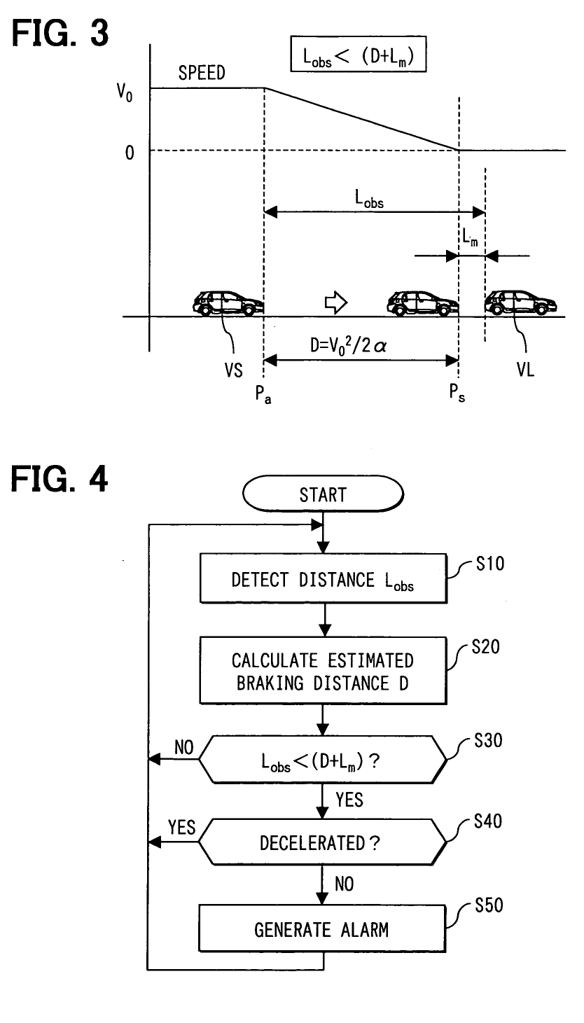

Referring to FIG. 3, the stop operation start distance determining device 82 calculates an estimated braking distance D when the driver has started the operation for stopping the vehicle VS from the present speed, compares a distance (D+Lm) obtained by adding, to the above calculated estimated braking distance D, a margin Lm of when the vehicle VS stops short of the halting vehicle VL with the distance Lobs up to the halting vehicle VL, determines whether the distance Lobs up to the halting vehicle VL is shorter than the distance (D+Lm), and sends the determination result to the driving operation determining device 84.

First, the stop operation start distance determining device 82 obtains the distance Lobs to the body in front such as the halting vehicle included in the body information from the laser radar sensor 30, and the speed Vo of the vehicle. Next, from this speed Vo, an estimated braking distance D for stopping the vehicle after the driver has started the operation for stopping the vehicle is calculated according to the following formula. The deceleration a in the following formula 1 is the one (normal deceleration) that occurs in the vehicle that is normally decelerated when the driver is going to stop the vehicle, and is set to be, for example, about 0.49 to about 2.94 (m/s²).
D=Vo²/(2α) (1)

From the above formula 1, the estimated braking distance D is calculated depending upon the speed Vo of the vehicle. The stop operation start distance determining device 82 compares the distance (D+Lm) obtained by adding, to the estimated braking distance D calculated according to the above formula, a margin Lm of when the vehicle VS stops short of the object such as a halting vehicle VL with the distance Lobs up to the halting vehicle VL, determines whether the distance Lobs up to the halting vehicle VL is shorter than the distance (D+Lm), and sends the determination result to the driving operation determining device 84. The margin Lm when the vehicle stops short of the object such as the halting vehicle is set to be, for example, about several meters.

The driving condition detecting device 83 detects the on/off of the accelerator pedal and of the brake pedal from the accelerator sensor 10 and the brake sensor 70, and sends the detected results to the driving operation determining device 84.

When the result of determination by the stop operation start distance determining device 82 is holding a relation of the following formula 2, the driving operation determining device 84 determines whether the driver of the vehicle is operating to stop the vehicle based on the result detected by the driving condition detecting device 83. The driving operation determining device 84 sends the determination result to the alarm generating device 85.
Lobs<D+Lm (2)

When the determination result from the stop operation start distance determining device 82 holds the relationship of the above formula 2, it is presumed that the driver of the vehicle usually starts decelerate the vehicle to stop it. When the detected result from the driving condition detecting device 83 is that the accelerator pedal is operated (accelerator pedal is operated toward the open side, accelerator is on) or is that the brake pedal is not operated (brake off) while in the relationship of the above formula 2, it is so determined that the driver's degree of recognition is low concerning the body existing ahead or is present in front of the vehicle (driver is not recognizing).

Namely, referring, for example, to FIG. 3, when the vehicle VL is halting in front of the vehicle VS that is traveling, the driver of the vehicle VS visually recognizes the halting vehicle VL, determines a point Pa where to start the driving operation for safely stopping the vehicle VS at a point Ps short of the halting vehicle VL, and starts deceleration (e.g., turn off the accelerator pedal or apply the brake) when the vehicle VS has arrived at the point Pa.

Therefore, if the driver does not start decelerating operation such as turning of f the accelerator pedal or applying the brake despite the vehicle has arrived at the point Pa, it can be presumed that the driver is not recognizing the presence of the halting vehicle VL in front of the vehicle VS that is traveling. When the relationship of the formula 2 is being held, therefore, it is determined whether the driver of the vehicle is operating to stop the vehicle thereby to properly determine the driver's degree of recognition of the traffic environment in front of the vehicle.

Upon receipt of the determination result from the driving operation determining device 84 that the driver of the vehicle is not operating to stop his vehicle, the alarm generating device 85 generates an alarm to cause the driver's attention to the front of the vehicle. This enables the driver to recognize the presence of the body in front of the vehicle.

Next, the alarm generation processing by the driving assisting apparatus 200, particularly computer 80, according to the characterizing part of the embodiment will be described with reference to a flowchart of FIG. 4.

At step (S) 10 of FIG. 4, first, a distance Lobs is detected up to the body such as a halting vehicle in front of the vehicle, and an estimated braking distance D is calculated at S20.

At S30, it is determined whether the distance Lobs up to the body is smaller than a distance obtained by adding a margin Lm to the estimated braking distance D. When the determination is affirmative, the routine proceeds to S40. When the determination is negative, the routine returns S10.

At S40, it is determined whether the vehicle is decelerated. This determination is made by checking whether the accelerator is on or the brake is off. When the determination is negative, the routine proceeds to S50. When the determination is positive, the routine returns S10 to repeat the above processing again. At S50, an alarm is generated to cause the driver's attention to the forward direction.

When the distance up to the body existing in front of the vehicle is shorter than a distance obtained by adding a margin to the estimated braking distance for stopping the vehicle by starting the ordinary deceleration operation for stopping the vehicle from the present speed, the apparatus 200 for assisting the driving of the vehicle determines whether the driver is operating to stop his vehicle. When it is determined that the driver is not operating to stop the vehicle, the alarm is generated to cause the driver's attention to the forward direction.

Therefore, when the accelerator pedal is maintained pressed down or the brake has not been applied despite the distance up to the body existing in front of the halting vehicle is shorter than the distance obtained by adding the margin to the estimated braking distance, it can be so determined that the driver's degree of recognition of the body ahead is low (or is not recognizing). It is therefore possible to properly determine the driver's degree of recognition of the traffic environment in front of the vehicle.

When the driver operates to stop his vehicle, the deceleration of a predetermined level occurs in the vehicle. It is therefore desired as a first modification to determine whether the deceleration of a predetermined level is occurring thereby to determine the driver's degree of recognition of the forward direction of the vehicle.

In this case, the driving operation determining device 84 stores the speed Vo of the vehicle at a moment when the determination result in the relationship of the above formula 2 is obtained from the stop operation start distance determining device 82, and an average deceleration αₐᵥₑ that occurs in the vehicle is calculated from the change (decrease) in the speed relative to the stored velocity Vo of the vehicle. It is determined whether the average deceleration αₐᵥₑ is larger than the normal deceleration α, and the determination result is sent to the alarm generating device 85.

When the determination result in that the average deceleration αₐᵥₑ is smaller than the normal deceleration α is received from the driving operation determining device 84, the alarm generating device 85 generates an alarm for causing the driver's attention to the forward direction of the vehicle. This enables the driver to recognize the presence of the body in front of the vehicle.

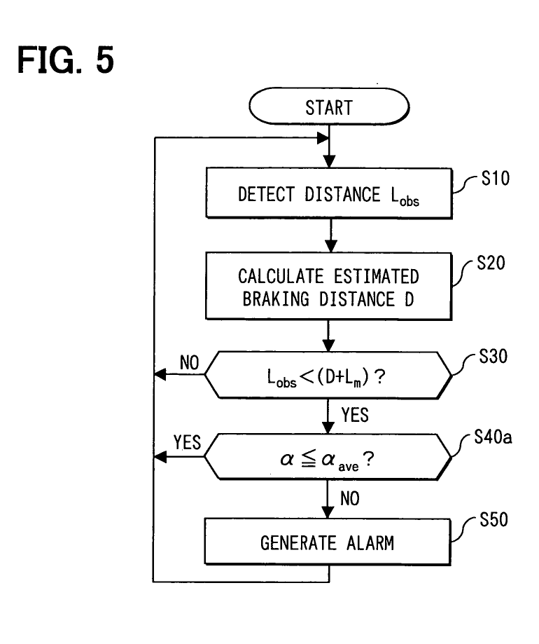

Next, the alarm generation processing will be described with reference to a flowchart shown in FIG. 5. Steps S10 to S30 and S50 are the same as those described in the first embodiment, and are not described here again.

At S40a in FIG. 5, it is determined whether the average deceleration αₐᵥₑ is larger than the normal deceleration α. When the determination is affirmative, the routine returns S10 to repeat the above processing again. When the determination is negative, the routine proceeds to S50 where an alarm is generated to cause the driver's attention to the forward direction.

When the deceleration (normal deceleration α) of not smaller than a predetermined level is not detected despite the distance up to the body such as a halting car existing in front is smaller than a distance obtained by adding a margin to the estimated braking distance, it can be determined that the driver's degree of recognition is low concerning a point where the vehicle is to be stopped (or is not recognizing). It is thus possible to properly determine the driver's degree of recognition of the traffic environment in front of the vehicle.

It is further possible as a second modification to detect a pedestrian crossing or an intersecting point where a stop is designated, a point where there is installed a signal that is turning a red sign on, a railroad crossing, a toll gate on a toll road or any other point where the vehicle must be stopped, and to determine whether a distance up to such a fixed stop point is shorter than a distance obtained by adding a margin to the estimated braking distance.

In this case, the stop operation start distance determining device 82 obtains signal data and stop point data transmitted from the navigation device 72, and detects a distance Lstp from the present position of the vehicle up to any one of a pedestrian crossing or an intersecting point where a stop is designated a stop point (position of a stop line) in an intersecting point where a signal is installed as a stop point (position of a stop line) in a railroad crossing or a toll gate installed on a toll roaD for the stop point at an intersection where a signal is installed, what is taken into an account is only a signal that is turning a red sign on based on signal information.

The stop operation start distance determining device 82 compares the distance Lstp up to the point where the vehicle is to be stopped with the distance (D+Lm) obtained by adding a margin Lm of when the vehicle is stopped short of a point where the vehicle is stopped to the estimated braking distance D calculated according to the formula 1, determines whether the distance Lstp up to the point of stop is shorter than the distance (D+Lm), and sends the determination result to the driving operation determining device 84.

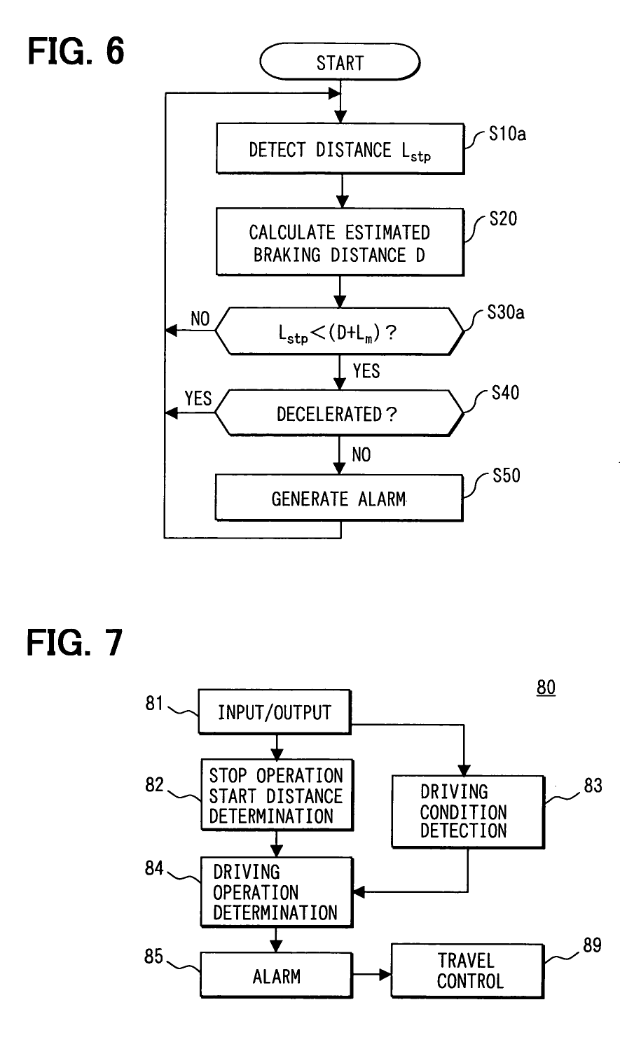

The alarm generation processing will now be described with reference to a flowchart illustrated in FIG. 6. Steps S20, S40 and S50 in FIG. 6 are the same as those described in the above embodiment, and are not described here again.

At S10a of FIG. 6, a distance Lstp is detected up to the stop point. At S30a, it is determined whether the distance Lstp up to the stop point is shorter than the distance (D+Lm). When the determination is affirmative, the routine proceeds to S40. When the determination is negative, the routine returns S10a to repeat the above processing again.

It is therefore possible to properly determine the driver's degree of recognition of the point in front of the vehicle where the vehicle is to be stopped. This processing (FIG. 6) can also be applied to the driving assisting apparatus 200, that renders the determination based on the deceleration of FIG. 5.

It is also possible as a third modification to impose limitation on the traveling of the vehicle simultaneously with the generation of alarm by the alarm generating device 85. FIG. 7 is a control block diagram of the computer 80 for imposing the limitation. Referring to FIG. 7, a vehicle travel controller 86 limits or disables the accelerator pedal from being operated toward the opening side (accelerator on side) upon receipt of the alarm generated from the alarm generating device 85.

Therefore, when, for example, the vehicle is going to collide the halting vehicle in front from behind, the shock can be relaxed. Further, the vehicle travel controller 86 may drive the brake actuator 100 to automatically apply the brake. This makes it possible to avoid collision with the halting vehicle in front from behind.

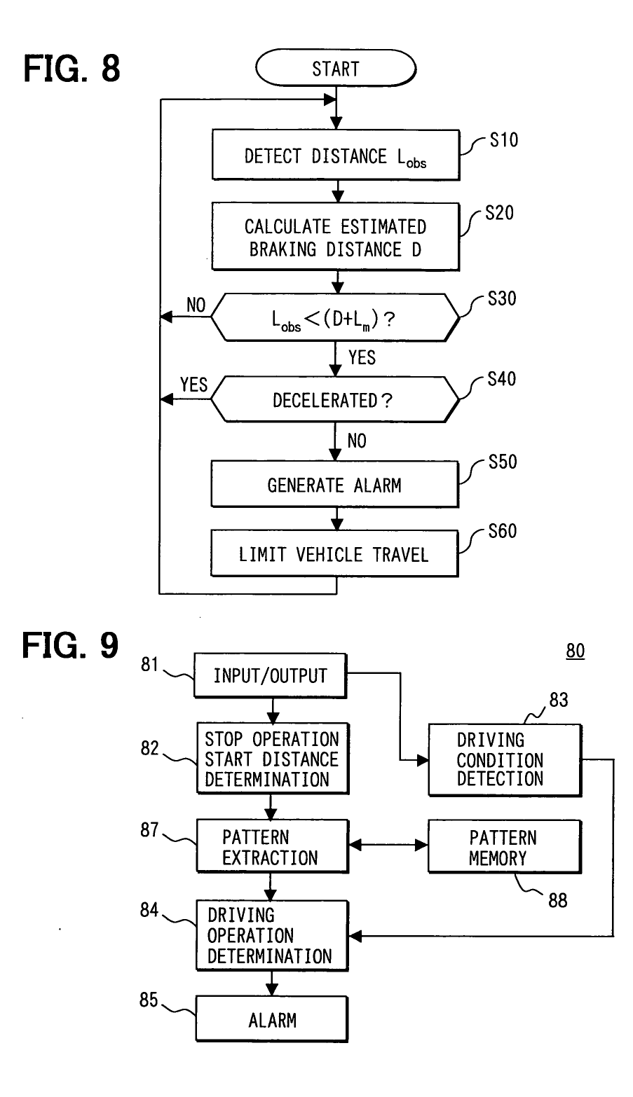

Next, the alarm generation processing will be described with reference to a flowchart illustrated in FIG. 8. Steps S10 to S50 in FIG. 8 are the same as those described in the above embodiment, and are not described here again. At S60 in FIG. 8, the vehicle travel is limited by limiting the accelerator from being further pressed as the alarm is generated. The routine, then, goes back to S10 to repeat the above processing again. This lowers the danger for the vehicle in the traffic environment in front.

### Second Embodiment

A second embodiment is similar to the first embodiment. In the second embodiment, however, attention is given to the driving operation for bringing the vehicle into a halt through a predetermined driving pattern in which the driver, usually, operates the accelerator toward the vehicle decelerating side (accelerator off) to decelerate the vehicle, and applies the brake (brake on) after having changed his foot from the accelerator pedal onto the brake pedal.

When it is determined that the distance up to the stop point is shorter than the predetermined distance, it is determined whether a standard driving operation is in match with the driving operation of the vehicle thereby to determine the driver's degree of recognition of the forward direction of the vehicle.

FIG. 9 is a control block diagram of the computer 80. Referring to FIG. 9, the control processing of the computer 80 is functionally divided into the blocks of an input/output device 81, a stop operation start distance determining device 82, a driving condition detecting device 83, a driving operation determining device 84, an alarm generating device 85, a driving operation pattern extraction device 87, and a driving operation pattern memory device 88. The input/output device 81 receives the signals from various sensors, and produces signals that are to be output after having been processed by the computer 80.

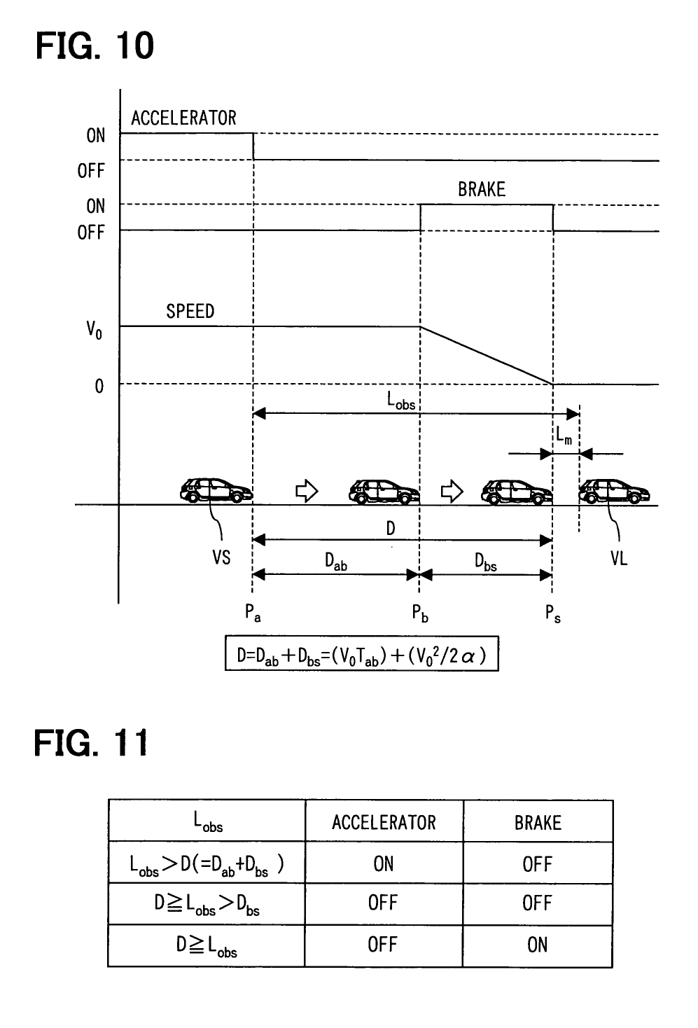

Referring to FIG. 10, the stop operation start distance determining device 82 calculates an estimated stopping distance D of when the driver has started the operation for stopping the vehicle VS from the present speed, compares a distance (D+Lm) obtained by adding, to the above calculated estimated stopping distance D, a margin Lm of when the vehicle VS stops short of the halting vehicle VL with the distance Lobs up to the halting vehicle VL, determines whether the distance Lobs up To the halting vehicle VL is shorter than the distance (D+Lm), and sends the determination result and the distance Lobs up to the halting vehicle VL to the driving operation pattern extraction device 87.

First, the stop operation start distance determining device 82 obtains the distance Lobs to the body in front such as the halting vehicle included in the body information from the laser radar sensor 30, and the speed Vo of the vehicle. Next, from this speed Vo, an estimated stopping distance D for stopping the vehicle after the driver has started the operation for stopping the vehicle is calculated according to the following formula.
D=Dab+Dbs=(VoTab)+(Vo²/(2×α)) (3)
where Dab is a distance as idle running distance which the vehicle travels during a period Tab required by the driver to change his foot from the accelerator pedal onto the brake pedal, and Dbs is an estimated braking distance of when the driver of the vehicle changes his foot onto the brake pedal and effects the normal deceleration operation. The deceleration α is the determination reference.

From the above formula 3, the estimated stopping distance D is calculated depending upon the speed Vo of the vehicle. The stop operation start distance determining device 82 compares the distance (D+Lm) obtained by adding, to the estimated stopping distance D calculated according to the above formula 3, a margin Lm of when the vehicle VS stops short of the body such as a halting vehicle VL with the distance Lobs up to the halting vehicle VL, determines whether the distance Lobs up to the halting vehicle VL is shorter than the distance (D+Lm), and sends the determination result and the distance Lobs up to the halting vehicle VL to the driving operation pattern extraction device 87.

The margin Lm when the vehicle stops short of the object such as the halting vehicle is set to be, for example, about several meters. In this embodiment, the idle running distance Dab is calculated by taking into consideration none of the deceleration due to the driving force of the engine or the motor, or the deceleration due to the traveling resistance to the vehicle. However, the final estimated stopping distance D may be calculated by taking them into consideration.

The driving operation detecting device 83 detects the on/off of the accelerator pedal and of the brake pedal from the accelerator sensor 10 and the brake sensor 70, and sends the detected results to the driving operation determining device 84.

The driving operation pattern extraction device 87 determines whether the determination result from the stop operation start distance determining device 82 is holding the relationship of the following formula,
Lobs<(D+Lm) (4)

When the relationship of the above formula 4 is maintained standard driving operation corresponding to the distance Lobs of from the stop operation start distance determining device 82 up to the halting vehicle VL is detected from the driving operation pattern memory device 88, and the standard driving operation that is extracted is sent to the driving operation determining device 84.

Referring to FIG. 11, the driving operation pattern memory device 88 stores standard driving operation patterns at the time when the driver stops the vehicle in relation to the distance up to a target stop position (point Ps in FIG. 10) which is a target of stop (i.e., being corresponded to the distance Lobs up to the halting vehicle VL). The idle running distance Dab and the estimated braking distance Dbs are arbitrarily updated depending upon a change in the speed Vo of the vehicle.

The driving operation pattern extraction device 87 detects a standard driving operation corresponding to the distance Lobs of up to the halting vehicle VL from the driving operation pattern memory device 88. When, for example, the distance Lobs up to the halting vehicle VL is holding the following relationship, there are detected the accelerator off and the brake off as the driving operation.
D≧Lobs>Dbs (5)

The driving operation determining device 84 determines whether the standard driving operation detected by the driving operation pattern extraction device 87 is in agreement with the present driving operation of the driver of the vehicle from the driving condition detecting device 83, and sends the determination results to the alarm generating device 85.

That is, when the standard driving operation extracted by the driving operation extraction device 87 is not in agreement with the present driving operation of the driver of the vehicle sent from the driving condition detecting device 83, it can be so presumed that the driver of the vehicle is driving in a manner different from the standard driving operation since his degree of recognition is low (is not recognizing) concerning the object such as a halting vehicle existing in front of the vehicle.

When the standard driving operation detected by the driving operation pattern extraction device 87 is not in agreement with the present driving operation of the driver of the vehicle sent from the driving condition detecting device 83, therefore, it can be so determined that the driver's degree of recognition is low concerning the traffic environment in front of the vehicle.

Upon receipt of a determination result from the driving operation determining device 84 in that the standard driving operation detected by the driving operation pattern extraction device 87 is not in agreement with the present driving operation of the driver of the vehicle from the driving condition detecting device 83, the alarm generating device 85 generates an alarm to cause the driver's attention to the forward direction of the vehicle. This enables the driver to recognize the presence of the body in front of the vehicle.

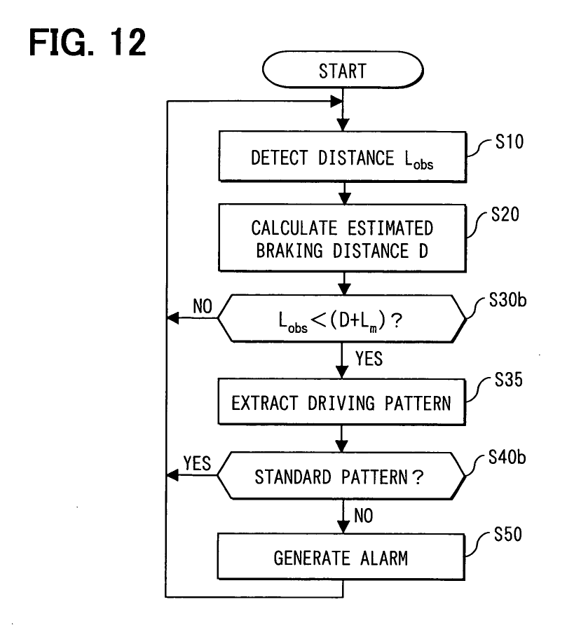

Next, the alarm generation processing will be described by using a flowchart illustrated in FIG. 12. At S10 of FIG. 12, first, a distance Lobs is detected up to the body such as a halting vehicle in front of the vehicle, and an estimated stopping distance D is calculated at S20.

At S30b, it is determined whether the distance Lobs up to the body is shorter than a distance obtained by adding a margin Lm to the estimated stopping distance D. When the determination is affirmative, the routine proceeds to S35. When the determination is negative, the routine returns S10.

At S35, a standard driving operation corresponding to the distance Lobs of up to the body is detected and at S40b, it is determined whether the standard driving operation (detected driving pattern) is in agreement with the present driver's driving operation. When the determination is affirmative, the routine returns S10 to repeat the above processing. When the determination is negative, the routine proceeds to S50 where an alarm is generated to cause the driver's attention to the forward direction.

When the distance Lobs up to the body is determined to be shorter than the distance obtained by adding the margin Lm to the estimated stopping distance D, the driving assisting apparatus 200 according to this embodiment determines whether the standard driving operation is in agreement with the driving operation by the driver of the vehicle. This makes it possible to properly determine the driver's degree of recognition of the traffic environment in front of the vehicle.

In the second embodiment, too, like in the modification of first embodiment, it is possible to detect a pedestrian crossing or an intersecting point where a stop is designated, a point where there is installed a signal that is turning a red sign on, a railro ad crossing, a toll gate on a toll road or any other point where the vehicle must be stopped, and to determine whether a distance up to the point is smaller than a distance obtained by adding a margin to the estimated braking distance.

Further, limitation may be imposed on the traveling of the vehicle simultaneously with the generation of an alarm by the alarm generating device 85.

The driving operation pattern memory device 88 according to the embodiment stores the standard driving operation pattern of the driver. When it is determined by the stop operation start distance determining device 82 that the distance Lobs up to the body is shorter than the distance obtained by adding the margin Lm to the estimated stopping distance D, however, the driving operation by the driver of the vehicle continued until the vehicle stops is detected, the driving operation pattern is formed from the driving operation detected above, a typical driving operation pattern of the driver of the vehicle is formed by using the thus formed driving operation pattern and the driving operation pattern stored in the driving operation pattern memory device 88 formed up to the previous time, and the thus formed typical driving operation pattern is stored in the driving operation pattern memory device 88.

The timings for turning the accelerator off or for applying the brake (i.e., points Pa, Pb in FIG. 10) differ depending upon the drivers. Therefore, the driving operation patterns of the driver of the vehicle are formed, a typical driving operation pattern is formed from the driving operation patterns formed up to the previous time, and the daily driving operation pattern of the driver is used as a standard driving operation pattern.

### Third Embodiment

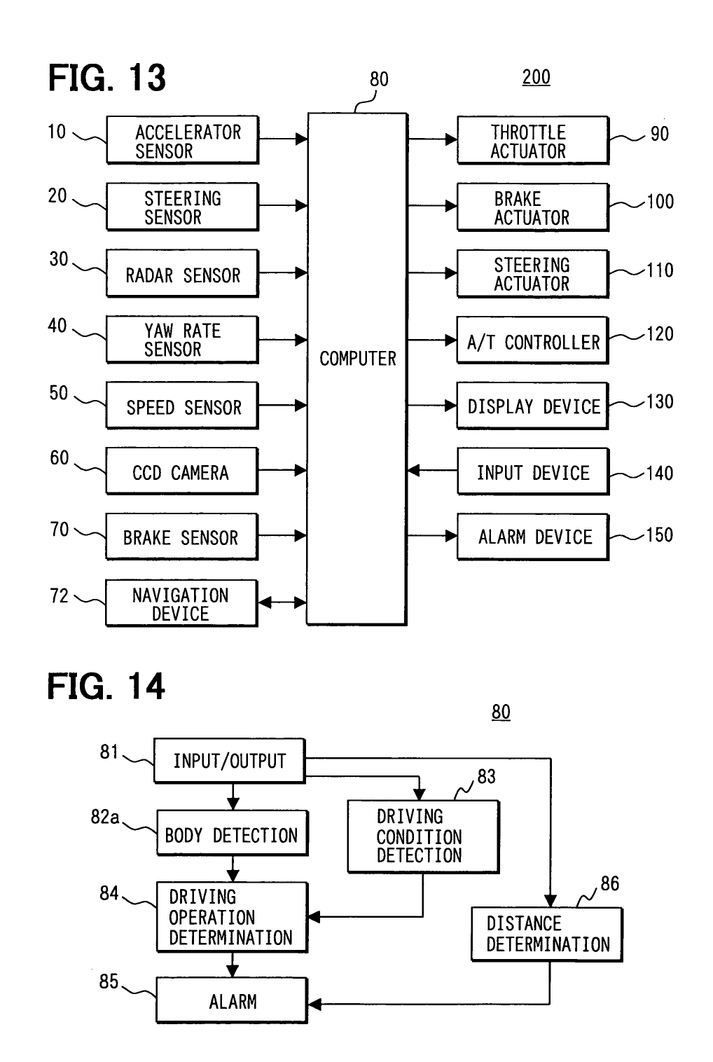

In this embodiment illustrated in FIG. 13, a vehicle driving assisting apparatus 200 is constructed in the same manner as that of the first and second embodiments. However, no communication device is provided. Further, a computer 80, too, is constructed in the same manner as in the first and second embodiments. However, the block 82 in the first and second embodiments is replaced with a body detecting device 82a. A distance determining device 85 is added and connected to an alarm generation device 85.

The input/output device 81 receives signals output from various sensors, and produces signals that are to be output after having been processed by the computer 80.

The body detecting device 82a detects body data such as a preceding traveling vehicle or a halting vehicle detected by the laser radar sensor 30. The driving condition detecting device 83 detects the operation (on/off) of the accelerator pedal and of the brake pedal from the accelerator sensor 10 and the brake sensor 70, and sends the detected result to the driving operation determining device 84.

When the body such as the preceding vehicle or the halting vehicle is detected by the body detecting device 82a, the driving operation determining device 84 determines whether the driving operation (e.g., turning the accelerator off or applying the brake) is executed to stop the vehicle short of the body based upon the detected result from the driving condition detecting device 83. The driving operation determining device 84 sends the determination result to the alarm generating device 86.

The distance determining device 85 determines whether the distance up to the body is shorter than a predetermined distance based on the body information from the laser radar sensor 30 and whether the amount of change in the distance for every predetermined period of time is within a predetermined amount of change. The distance determining device 85 sends the determination result to the alarm generating device 86.

Upon receipt of the determination result from the driving operation determining device 84 in that the driver of the vehicle is not executing the driving operation for stopping the vehicle, the alarm generating device 86 generates an alarm for causing the driver's attention to the body in front of the vehicle. Further, upon receipt of the determination result from the distance determining device 85 in that the distance up to the forward of the vehicle is shorter than the predetermined distance and that the amount of change in the distance for every predetermined period of time is smaller than a predetermined amount of change, the alarm generating device 86 executes the processing for discontinuing attracting the driver's attention to the body.

That is, when the distance up to the body in front of the vehicle is shorter than the predetermined distance but when the amount of change in the distance is small, the driver of the vehicle so determines that he can trace the preceding body by adjusting the speed of his car depending upon a change in the distance relative to the preceding body.

Therefore, even when the driving operation is not executed for stopping the vehicle short of the object existing in front of the vehicle, attracting the driver's attention to the body is discontinued provided the distance up to the body is shorter than the predetermined distance and the amount of change in the distance for every predetermined period of time is smaller than the predetermined amount of change. Thus, when the driver of the vehicle follows the preceding vehicle, attention to the obstacles is not caused other than the preceding vehicle. Therefore, the driver of the vehicle is not provided with bothersome information.

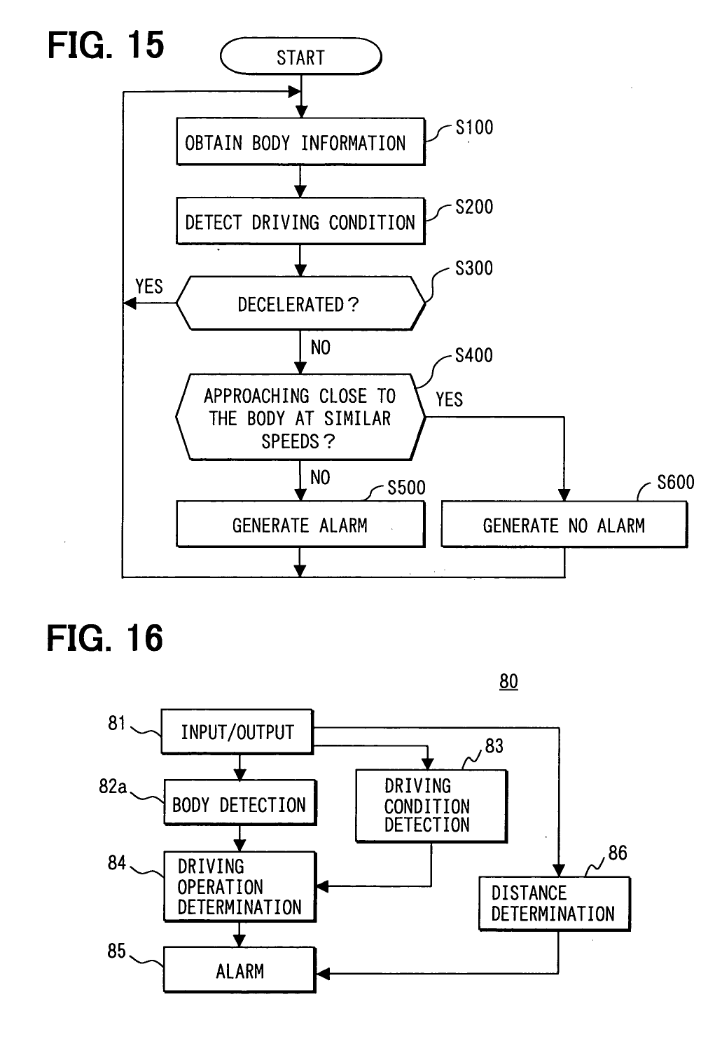

Next, this embodiment will be described with reference to a flowchart of FIG. 15. At step (S) 100, first, body information of obstacles such as the preceding vehicle or the halting vehicle in front of the vehicle is obtained from the laser radar sensor 30. At S200, the driving condition of the driver is detected from the accelerator sensor 10 and the brake sensor 70.

At S300, it is determined whether the information of the object in front of the vehicle is detected at S100 and is further determined whether the driver's driving condition (i.e., turning the accelerator off or applying the brake) for stopping the vehicle is detected at S200. This makes it possible to determine whether the vehicle is decelerated and the driver is recognizing the body in front of the vehicle. When the determination is affirmative, the routine returns S100 to repeat the above processing. When the determination is negative, the routine proceeds to S400.

At S400, it is determined whether the vehicle is approaching close to the body at similar speeds. This is, it is determined whether the distance to the body is shorter than the predetermined distance, and further whether the amount of change in the distance for every predetermined period of time is smaller than a predetermined amount of change. When the determination is affirmative, the routine proceeds to S600. When the determination is negative, an alarm is produced at S500. At S600, no alarm is generated or the alarm for causing the driver's attention to the body is discontinued.

In this embodiment, the body in front of the vehicle is detected, the alarm is generated when the driving operation has not been executed for stopping the vehicle short of the body that is detected, and attraction of the driver's attention to the body is discontinued when the distance to the detected body is shorter than the predetermined distance and when the amount of change in the distance for every predetermined period of time is smaller than the predetermined amount of change.

Therefore, when the driver travels following the preceding vehicle in front of his vehicle, attention to the obstacles is not caused other than the preceding vehicle. Therefore, the driver of the vehicle is not provided with bothersome information.

As a modification of the third embodiment, when any point where the vehicle must be stopped is detected, it is possible to determine whether the driving operation has been executed to stop the vehicle short of the above detected point. Such a stop point includes a road sign designating a stop in front of the vehicle, a pedestrian crossing or an intersecting point where a road sign is installed, a signal that is turning a red sign on, a railroad crossing, a toll gate on a toll road or the like.

In this case, as illustrated in FIG. 16, the body detecting device 82a is constructed to detect the stop point information transmitted from the navigation device 72 to detect the pedestrian crossing or intersection where a stop is designated in front of the vehicle, to detect the stop point (position of stop line) in the intersection where a signal is installed, to detect a stop point (position of stop line) in the railroad crossing, or to detect a point where a toll gate is installed on a toll road, and the driving operation determining device 84 determines whether the driving operation is executed to stop the vehicle short of the point that is detected.

As for the stop point in the intersection where a signal is installed, a color (red, yellow or green) of the signal existing in front of the vehicle is detected based on an image pictured by the CCD camera 60, and only the signal turning red on as a result of determination may be taken into account.

### Fourth Embodiment

The driving assisting apparatus 200 according to the fourth embodiment generates an alarm for causing the driver's attention to the body in front of the vehicle. When the amount of change in the speed relative to the body for every predetermined period of time is smaller than a predetermined amount of change, the apparatus so determines that the vehicle is following the body maintaining a proper relationship to the body, and discontinues the attraction of the driver's attention to the body.

That is, even when the amount of change in the speed relative to the preceding vehicle which is the body is small, it is so determined that the driver of the vehicle is adjusting the speed of his vehicle depending upon a change in the speed of the preceding vehicle. When the amount of change in the relative speed is smaller than a predetermined amount of change, therefore, it can be so determined that the driver is driving the vehicle so as to maintain a proper relation relative to the preceding vehicle.

Even when the driving operation is not executed to stop the vehicle short of the body, therefore, the attraction of the driver's attention to the body is discontinued provided he is traveling maintaining a proper relationship to the body. Thus, when the driver follows the body in front of the vehicle, such as the preceding vehicle, the driver's attention is not caused for the obstacles other than the preceding vehicle, and the driver of the vehicle is not provided with bothersome information.

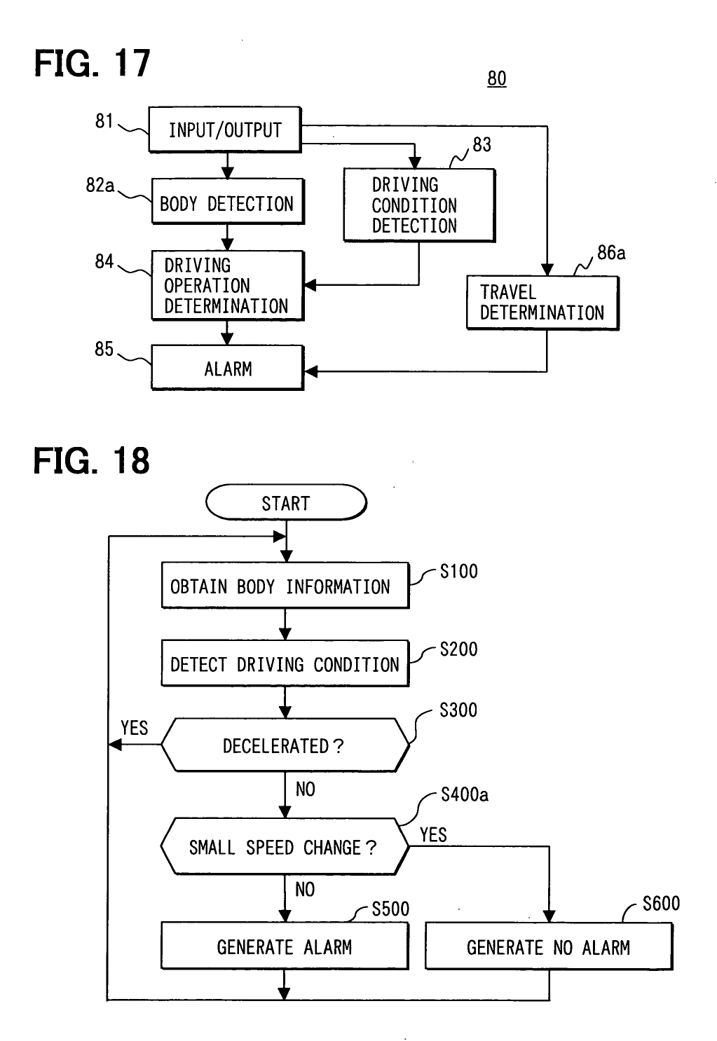

FIG. 17 is a control block diagram of the computer 80 according to the embodiment. Referring to FIG. 17, the control processing of the computer 80 of this embodiment is divided into blocks of an input/output device 81, a body detecting device 82a, a driving condition detecting device 83, a driving operation determining device 84, a travel determining device 85a and an alarm generating device 86.

Based on the information from the laser radar sensor 30, the travel determining device 85a calculates the amount of change in the speed relative to the body in front of the vehicle for every predetermined period of time, and determines whether the amount of change in the relative speed is smaller than the predetermined amount of change. The travel determining device 85a sends the determination result to the alarm generating device 86.

Upon receipt of the determination result from the driving operation determining device 84 in that the driver of the vehicle is not executing the driving operation for stopping the vehicle, the alarm generating device 86 generates an alarm for causing the driver's attention to the body. Upon receipt of the determination result from the travel determining device 85 in that the amount of change in the relative speed is smaller than a predetermined amount of change, the alarm generating device 86 executes the processing for discontinuing the attraction of the driver's attention to the body.

Next, the alarm generation processing will be described with reference to the flowchart illustrated in FIG. 18.

At S400a, it is determined whether the amount of change in the speed relative to the body existing in front of the vehicle is smaller than the predetermined amount of change. When the determination is affirmative, the routine proceeds to S600 to generate no alarm or discontinue the attraction of the driver's attention to the body. When the determination result is negative denied, an alarm is generated at step S500.

In this embodiment, too, an alarm is generated to cause the driver's attention to the body when the driving operation has not been executed to stop the vehicle short of the body in front of the vehicle. When the amount of change in the speed relative to the body in front of the vehicle is smaller than the predetermined amount of change, however, attraction of the driver's attention to the body is discontinued. When the vehicle is tracing the body in front of the vehicle, such as the preceding vehicle, therefore, attention is not caused for the obstacles other than the preceding vehicle. As a result, the driver of the vehicle is not provided with bothersome information.

In the fourth embodiment, it may be determined whether the vehicle is traveling maintaining a proper relationship to the preceding vehicle based on the amount of change in the distance to the preceding vehicle.

That is, when, for example, the amount of change in the distance to the preceding vehicle is small, it can be so determined that the driver of the vehicle is adjusting the speed of his car depending on a change in the distance to the preceding vehicle. Therefore, when the amount of change in the distance between cars is smaller than a predetermined amount of change, it can be presumed that the driver is driving the vehicle so as to maintain a suitable relationship to the preceding vehicle.

When the body is a preceding vehicle, it may be determined whether the vehicle is traveling maintaining a suitable relationship to the preceding vehicle based on the result of detecting the driving operation (accelerator off or brake on) for decelerating the vehicle accompanying the turn on of the brake lamp of the preceding vehicle.

That is, when the driving operation (accelerator off or brake on) for decelerating the vehicle is detected accompanying the turn on of the brake lamp of the preceding vehicle, it can be so determined that the driver has decelerated his vehicle upon recognizing the deceleration of the preceding vehicle. Therefore, when the driving operation for decelerating the vehicle is detected after the detection of turn-on of the brake lamp of the preceding vehicle, it can be so determined that the driver is driving the vehicle so as to maintain a suitable relationship to the preceding vehicle. The turn on/off of the brake lamp of the preceding vehicle may be detected from a change in the brightness of the brake lamp by detecting the brake lamp of the preceding vehicle existing in front of the vehicle by using the CCD camera 60.

### Fifth Embodiment

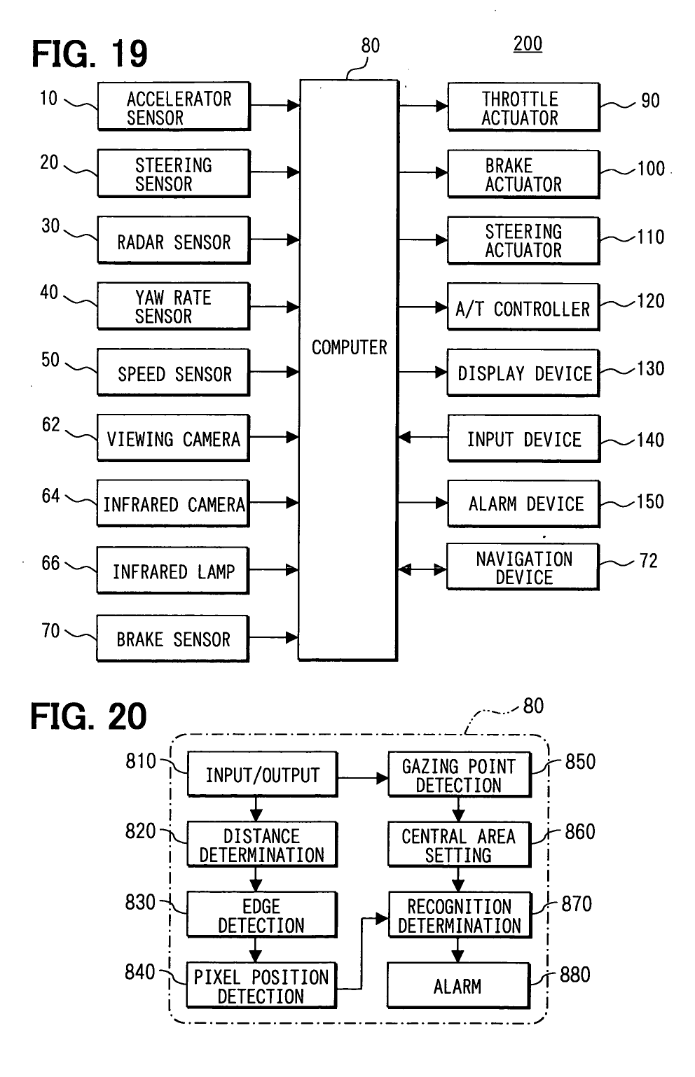

A vehicle driving assisting apparatus 200 of this embodiment, too, is constructed in the same manner as in the first to fourth embodiments. As illustrated in FIG. 19, however, a viewing camera 62, an infrared ray camera 64 and an infrared ray projection lamp 66 instead of the CCD camera 60 (FIGS. 1, 13).

The computer 80 determines the driver's degree of recognition of the road facilities based on whether the road facilities such as a traffic signal and a stop sign located at a distance that can be viewed by the driver and included in a central viewing area based on a gazing point of when the driver of the vehicle gazes a distance of the road, are included in the central viewing area of the driver. An alarm is generated when it is determined that the driver's degree of recognition is low, and an alarm generation processing is executed for causing the driver's attention to the road facilities existing in front of the vehicle.

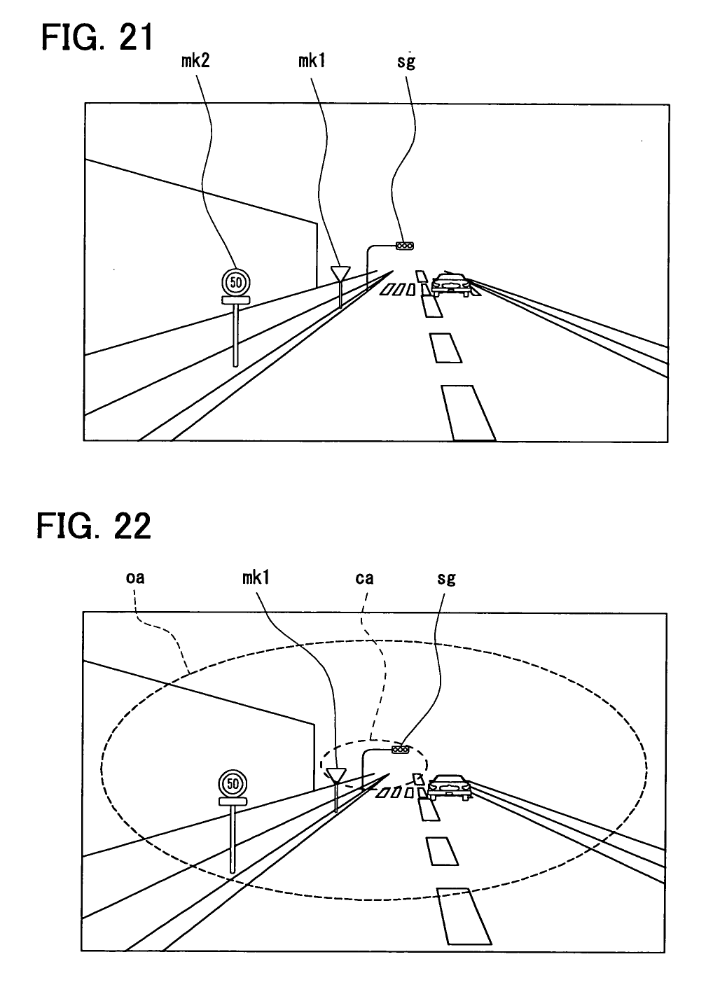

The viewing camera 62 is an optical camera which is installed at a position for imaging the forward direction of the vehicle. The viewing camera 62 takes an image, as shown in FIG. 21, including road facilities such as a road in the forward direction of the vehicle, a traffic signal sg installed along the road a stop sign mk1, and a speed-limit sign mk2.

In response to the instructions from the computer 80, the viewing camera 62 adjusts the shutter speed, frame rate and output gain of the digital signal output to the computer 80. Further, the viewing camera 62 sends digital signals of pixel values representing the degree of brightness for each of the pixels of the image that is taken to the computer 80 together with the horizontal and vertical synchronizing signals of the image that is taken.

The infrared ray camera 64 is for imaging the driver's face to which infrared ray is projected from an infrared ray projection lamp 64. The image of the face that is taken is used for detecting the position of the driver's viewing point and a point in front of the vehicle which the driver is gazing. The brake sensor 70 detects the amount of operation of the brake pedal by the driver. The signal of the brake pedal operation amount is sent to the computer 80.

Referring to FIG. 20, the control processing of the computer 80 is functionally divided into the blocks of an input/output device 810, a distance determining device 820, an edge detection device 830, a pixel position detection device 840, a gazing point detecting device 850, a central viewing area-setting device 860, a recognizing degree determining device 870, and an alarm generating device 880.

The distance determining device 820 obtains distance information representing a distance from the navigation device 72 through the input/output device to a position where there is installed a road facility such as a traffic signal or a stop sign, and determines whether the distance up to the road facility is a distance that can be viewed by the driver and is a distance from the vehicle that is included in the central viewing area based on a gazing point when the driver of the vehicle is gazing a distance of the road. The determination result is sent to the edge detecting device 830.

It has been known that, in general, the driver looks at a distant position from the vehicle as the speed of the vehicle increases and looks at the vicinity of the vehicle as the speed of the vehicle becomes low. Therefore, the distance included in the central viewing area varies depending upon the speed of the vehicle so as to meet the point which the driver gazes depending upon the speed. Further, the distance which can be viewed by the driver varies depending upon the eyesight of the driver. Therefore, the distance that can be viewed may be varied depending upon the eyesight of the driver.

When the distance determining device 820 determines the road facility at a distance that can be viewed by the driver and at a distance from the vehicle included in the central viewing area based on a gazing point of when the driver of the vehicle is gazing a distance of the road, the edge detecting device 830 detects the edge for detecting the road facility from the image taken by the viewing camera 620.

The edge detecting device 830, first, obtains only those pixel values of the pixels on a horizontal line corresponding to the distance determined by the distance determining device 820 out of the pixel values of the pixels of the image taken by the viewing camera 620. Namely, the image taken by the viewing camera 620 is fixed in the direction of imaging and from which the distance from the vehicle can be grasped in advance for every horizontal line of the image in the forward direction of the vehicle. It is, therefore, possible to obtain pixel values of only a horizontal line corresponding to the distance determined by the distance determining device 820. The values of the pixels that can be obtained in this embodiment are, for example, 0 to 255 (256 gradations).

Next, the edge detecting device 830 compares the pixel values of pixels on the horizontal line that is obtained with a preset threshold edge value and detects the edge by detecting the pixel positions having pixel values greater than the threshold edge value. The threshold edge value is set based, for example, upon a pixel value of a body such as a traffic signal, a stop sign or the like that is usually imaged by the viewing camera 620. By using the thus set threshold edge value, only those pixels corresponding to the signal or to the stop sign are detected.

The pixel position detection device 840 detects the pixel position corresponding to the signal or the stop sign detected by the edge detecting device 830.

The gazing point detecting device 850 detects a position of a point viewed by the driver based on the image of the face imaged by the infrared ray camera 64, detects the positions of a plurality of feature points (e.g., upper part of the eye, corner of the eye, etc.) from the image of the face, to specify a direction in which the face of the driver is facing. The gazing point detecting device 850 further detects the position of pupil of the driver from the image of his face, and estimates the gazing point of the driver in the windshield based on the direction in which the face is directed and the position of the pupil.

From a relationship between the gazing point in the windshield and the viewing position of the driver that are estimated, the computer 80 calculates, by coordinate conversion, the position of the gazing point in the image pictured by the camera 62, that is corresponding to the gazing point in the windshield.

The central viewing area-setting device 860 sets, on the image, the central viewing area based on the position of the gazing point in the image of the driver finally calculated by the gazing point detecting device 850. Specifically, the central viewing area-setting device 860 specifies the pixel position that represents the boundary of the central viewing area with the pixel position of the gazing point as a reference.

The central viewing area is usually in the shape of a circle (ellipse) of a predetermined angular range in the up-and-down and left-and-right direction in the direction of gaze. As illustrated in, for example, FIG. 22, therefore, it is possible to grasp a positional relationship between the road facilities and the central viewing area ca set on the image pictured by the viewing camera 62. FIG. 22 also illustrates a case where the surrounding viewing area oa is set on the image.

The recognizing degree determining device 870 determines whether the pixel position corresponding to the signal or the stop sign detected by the pixel position detection device 840 exists in the central viewing area set by the central viewing area setting device 860, and sends the determination result to the alarm generating device 880.

When the determination result from the recognizing degree determining device 870 is such that the pixel position corresponding to the signal or the stop sign is not in the central viewing area, the alarm generating device 880 determines that the driver of the vehicle is not recognizing the presence of the signal or the stop sign in front of the vehicle, and generates an alarm for causing the driver's attention to the signal or the stop sign existing in front of the vehicle.

That is, the moving body such as a preceding vehicle or a pedestrian may or may not appear in front of the vehicle depending upon the traffic conditions. Therefore, the driver of the vehicle surveys the surrounding in front of the vehicle to recognize the moving body at an early time. On the other hand, the road facilities which are the fixed bodies such as road signs inclusive of a traffic signal and a stop sign installed on the road where the vehicle is traveling, necessarily appear in front of the vehicle as the vehicle travels on the road. Upon viewing the road in front of the vehicle, therefore, the driver of the vehicle recognizes the road facilities at an early time.

In this embodiment, therefore, when a relationship of the distance to the road facility such as the signal or the stop sign which is the fixed body satisfies a predetermined condition (i.e., a distance that can be viewed by the driver and is included in the central viewing area), the driver's degree of recognition of the road facility is determined depending upon whether the road facilities exist in the present driver's central viewing area.

This makes it possible to properly determine the driver's degree of recognizing the presence of road signs such as a traffic signal and a stop sign which necessarily appear in front of the vehicle and which are necessary for driving the vehicle. This enables the driver to be informed of the presence of the road facility that is determined to have been not recognized at an early time (overlooked) by the driver.

A person's visual field can be divided into a region (central viewing area) based on a gazing point which the person is gazing and the periphery (peripheral viewing area). In general, a person can recognize what it is when he sees it in his central viewing area but finds it difficult to recognize what it is when he sees it in the peripheral viewing area. This tendency becomes conspicuous as the viewing point separates away from the central viewing area. Therefore, upon determining whether the distance can be viewed by the driver and whether the distance is included in the central viewing area, it is possible to specify the road facilities that should be recognized at an early time by the driver of the vehicle.

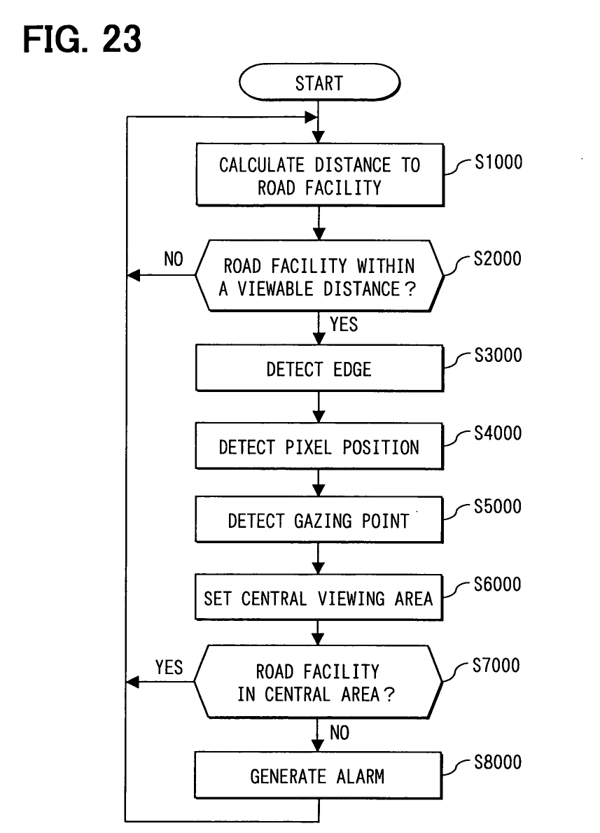

Next, alarm generation processing will be described with reference to a flowchart illustrated in FIG. 23. At step (S) 1000 in FIG. 23, first, the navigation device 72 calculates the distance up to the road facility such as a traffic signal or a stop sign existing in front of the vehicle.

At S2000, it is determined whether the distance up to the road facility that is calculated is the one that can be viewed by the driver. It is further determined at S2000 whether it is the distance included in the central viewing area based on the gazing point when the driver of the vehicle gazes a distance of the road. When the determination is affirmative, the routine proceeds to S3000. When the determination is negative, the routine returns to S1000 to repeat the above processing.

At S3000, the edge is detected by detecting the pixels of road facilities included from a distance based on the central viewing area up to the distance that can be viewed by the driver out of the image in front of the vehicle shot by the viewing camera 62. At S4000, the pixel positions are detected as detected at S3000.

At S5000, the gazing point of the driver is detected to calculate the position corresponding to the detected gazing point in the image pictured by the viewing camera 62. At S6000, the central viewing area of the driver is set based on the position of the gazing point in the image calculated at S5000. At S7000, it is determined whether the road facilities such as a traffic signal and a stop sign detected at S4000 exist in the central viewing area that is set.

When the determination is affirmative, the routine returns S1000 to repeat the above processing. When the determination is negative, the road facilities do not exist in the central viewing area. It is therefore so determined that the driver's degree of recognition of the road facilities is low, and an alarm is generated at S8000 to cause the driver's attention to the forward direction.

In this embodiment as described above, the driver's degree of recognition of the road facilities is determined depending upon whether the road facilities such as a traffic signal and a stop sign positioned on the distance that can be viewed by the driver and are located on the distance included in the central viewing area based on a gazing point of when the driver of the vehicle is gazing a distance of the road, are included in the present central viewing area of the driver.

When the signal or the stop sign is not located in the present central viewing area of the driver, it is determined that the driver's degree of recognition is low, and an alarm is generated to cause the driver's attention to the signal or the stop sign present in front of the vehicle.

This makes it possible to properly determine the driver's degree of recognition of the presence of road signs such as a traffic signal and a stop sign that necessarily appear in front of the vehicle and that are necessary for the driving. As a result, the driver of the vehicle is informed of the presence of the road facilities which were not recognized (overlooked) by the driver at an early time.

In this embodiment, the timing for generating the alarm may be varied depending upon the length from the boundary of the central viewing area.

When, for example, viewing the situations in front of the vehicle from a distance, the height of installing the signal existing outside the central viewing area and the height of installing the road facility such as a stop sign are not so much different as viewed from the driver of the vehicle, and the lengths thereof are not much different from the boundary of the central viewing area.

As the vehicle approaches the traffic signal or the road sign, however, the difference in the height of installation becomes conspicuous, and the difference in the length from the boundary of the central viewing area becomes great, too. When the length from the central viewing area is small, the facility which does not exist in the central viewing area may appear in the central viewing area as the driver's gazing point moves to some extent. It is, then, probable that the driver may recognize the road facility. When the length from the central viewing area is great, on the other hand, it is less probable that the road facility is located within the central viewing area, and it is presumed that the driver may not recognize it.

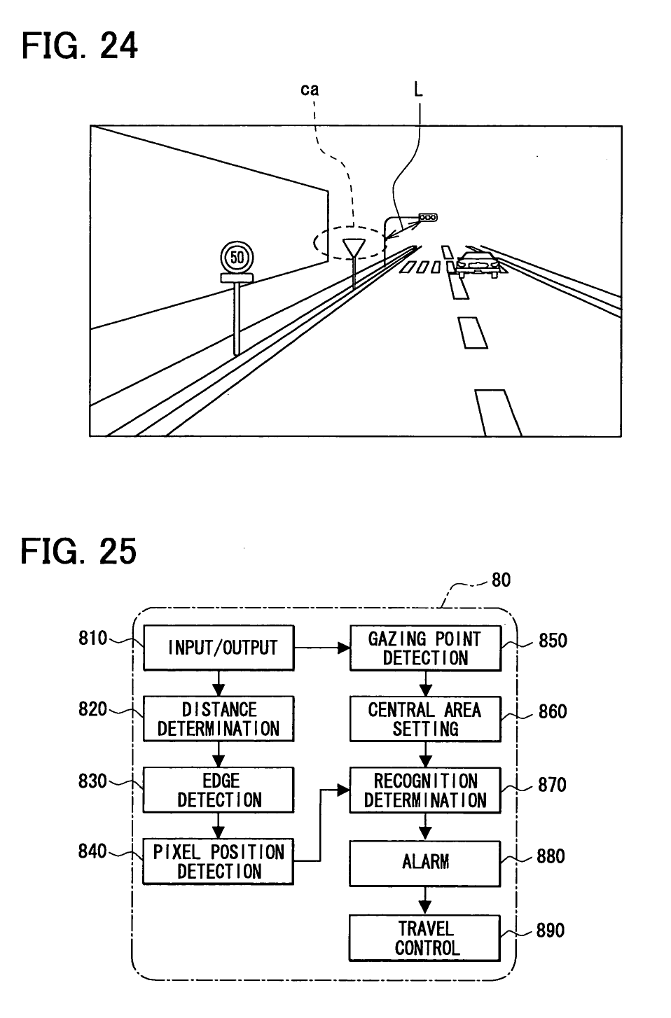

As illustrated in FIG. 24 as a first modification, therefore, the timing for causing the attention to the road facility is quickened when the length L is great from the boundary of the central viewing area ca. This causes attention to the road facilities such as a traffic signal and a stop sign necessary for the driving, for which it is determined that the driver's degree of recognition is low.

It is further allowable to impose limitation on the traveling of the vehicle simultaneously with the generation of alarm by the alarm generating device 880. Referring to FIG. 25 showing a second modification, upon receipt of an alarm generated from the alarm generating device 880, a vehicle travel control device 890 sends an instruction to the throttle actuator 90 for limiting the operation of the accelerator on the vehicle accelerating side (accelerator on side). This relaxes the shock in case the vehicle collides from behind with the preceding vehicle that is halting near the stop sign.

The vehicle travel control device 890 may drive the brake actuator 100 to stop the vehicle. This enables the vehicle to automatically stop short of the road facility such as the signal or the stop sign necessary for the driving.

Even when limitation is imposed on the traveling of the vehicle simultaneously with the generation of alarm, it is allowable to vary the timing for imposing the limitation on the traveling depending upon the length of the road facility such as the signal or the stop sign from the central viewing area.

This makes it possible to start imposing limitation on the traveling for the road facilities such as a traffic signal and a stop sign necessary for the driving, for which it is determined that the driver's degree of recognition is low.

The present invention should not be limited to the disclosed embodiments and modifications but may be implemented in many other ways without departing from the spirit of the invention.

1. A vehicle driving assisting apparatus comprising:
driving condition detecting means for detecting a driving operation of at least either an accelerator condition or a brake condition of a vehicle;
stopping point detecting means for detecting a stopping point in front of the vehicle and for calculating a distance up to the stopping point;
distance determining means for determining whether a distance up to the stopping point is shorter than a predetermined distance; and
driving operation determining means which, when the distance up to the stopping point is determined to be shorter than the predetermined distance, determines whether a vehicle driver is executing a driving operation for stopping the vehicle short of the stopping point based on a detected result of the driving condition detecting means thereby to determine a driver's degree of recognition of traffic environment in front of the vehicle.

2. The vehicle driving assisting apparatus according to claim 1, wherein the driving operation determining means so determines that the vehicle driver is not executing the driving operation for stopping the vehicle short of the stopping point, when a determination result of the driving condition detecting means indicates at least either a vehicle acceleration operation or no braking.

3. The vehicle driving assisting apparatus comprising:
deceleration detecting means for detecting a deceleration occurring on a vehicle;
stopping position detecting means for detecting a stopping point in front of the vehicle and for calculating a distance up to the detected point;
distance determining means for determining whether the distance up to the stopping point is shorter than a predetermined distance; and
deceleration level determining means which, when the distance determining means so determines that the distance up to the stopping point is shorter than the predetermined distance, determines whether the deceleration of a predetermined level is detected by the deceleration detecting means thereby to determine a driver's degree of recognizing a traffic environment in front of the vehicle.

4. The vehicle driving assisting apparatus according to claim 3, wherein the deceleration level determining means determines whether the deceleration of a level necessary for stopping the vehicle short of the body is detected as the deceleration of the predetermined level.

5. A vehicle driving assisting apparatus comprising:
driving condition detecting means for detecting a driving operation of at least either an accelerator condition or a brake condition of a vehicle;
stopping point detecting means for detecting a stopping point in front of the vehicle and for calculating a distance up to the stopping point;
distance determining means for determining whether the distance up to the stopping point is shorter than a predetermined distance;
driving operation pattern memory means for storing a pattern of a standard driving operation at the time of stopping the vehicle in relation to a distance of up to a target position;
driving operation extraction means which, when the distance up to the stopping point is determined to be shorter than the predetermined distance, extracts a standard driving operation corresponding to the distance of up to the stopping position from the driving operation pattern memory means; and
driving operation determining means for determining whether the driving operation detected by the driving condition detecting means is in agreement with the standard driving operation thereby to determine a driver's degree of recognition of the traffic environment in front of the vehicle.

6. The vehicle driving assisting apparatus according to claim 5, wherein the pattern memory means includes:
driving operation memory means which, when the distance up to the stopping point is determined by the distance determining means to be shorter than the predetermined distance, stores the driving operation detected by the driving condition detecting means from the predetermined distance up to when the vehicle is stopped short of the stopping point in relation to the distance of up to the stopping point;
driving operation pattern forming means for forming a pattern of the driving operation from the distance stored in the driving operation memory means up to when the vehicle is stopped short of the stopping point; and
a typical driving operation pattern forming means for forming a pattern of the typical driving operation based upon the pattern of the driving operation formed by the driving operation pattern forming means and upon the patterns of the driving operations formed up to the previous time,
wherein the driving operation pattern memory means stores the pattern of the typical driving operation formed by the typical driving operation pattern forming means as the pattern of the standard driving operation.

7. The vehicle driving assisting apparatus according to claim 5, wherein the driving operation determining means determines that the driver is little recognizing the traffic environment in front of the vehicle, when the driving operation is not in agreement with the standard driving operation.

8. The vehicle driving assisting apparatus according to claim 1, wherein the stopping point detecting means detects a point where an object is located in front of the vehicle as the stopping point.

9. The vehicle driving assisting apparatus according to claim 1, wherein the stopping point detecting means detects at least either stop point or a point where a signal is installed turning a red sign on, as the stopping point.

10. The vehicle driving assisting apparatus according to claim 1, further comprising:
speed detecting means for detecting a speed of the vehicle,
wherein the distance determining means includes predetermined distance-varying means for varying a length of the predetermined distance depending upon the speed of the vehicle detected by the speed detecting means.

11. The vehicle driving assisting apparatus according to claim 1, further comprising:
alarm means for causing the driver's attention when it is determined that the driver is little recognizing the traffic environment in front of the vehicle.

12. The vehicle driving assisting apparatus according to claim 1, further comprising:
travel limiting means for imposing limitation on the traveling of the vehicle when it is determined that the driver is little recognizing the traffic environment in front of the vehicle.

13. The vehicle driving assisting apparatus according to claim 12, wherein the travel limiting means limits the operation of the accelerator.

14. The vehicle driving assisting apparatus according to claim 12, further comprising:
braking means for driving a brake device,
wherein the travel limiting means automatically applies braking upon the braking means to impose the limitation on the traveling of the vehicle.

15. A vehicle driving assisting apparatus comprising:
driving condition detecting means for detecting a driving operation of at least either an accelerator operation or a brake operation of a driver;
body detecting means for detecting a body in front of a vehicle;
driving operation determining means for determining, based upon a detected result of the driving condition detecting means, whether the driving operation for stopping the vehicle short of the body detected by the body detecting means is being executed;
distance determining means for calculating a distance up to the body and for determining whether the distance is shorter than a predetermined distance and whether an amount of change in the distance for every predetermined period of time is smaller than a predetermined amount of change; and
alarm means for causing thedriver's attention to the body when the driving operation has not been executed for stopping the vehicle,
wherein the alarm means includes discontinuing means for discontinuing an alarm when the distance up to the body is shorter than the predetermined distance and that the amount of change is smaller than the predetermined amount of change despite that the driving operation has not been executed for stopping the vehicle.

16. The vehicle driving assisting apparatus according to claim 15, further comprising:
speed detecting means for detecting a speed of the vehicle,
wherein the distance determining means includes predetermined distance-varying means for varying the predetermined distance depending upon the speed of the vehicle.

17. A vehicle driving assisting apparatus comprising:
driving condition detecting means for detecting a driving operation of at least either an accelerator operation or a brake operation of a driver;
body detecting means for detecting a body in front of the vehicle;
driving operation determining means for determining, based on a detected result of the driving condition, whether the driving operation for stopping the vehicle short of the body is being executed;
travel determining means for determining whether the vehicle is following the body maintaining a suitable relationship thereto based on the information of a preceding vehicle;
alarm means for causing a driver's attention to the body detected by the body detecting means when the driving operation has not been executed for stopping the vehicle,
wherein the alarm means includes discontinuing means for discontinuing an alarm when the vehicle is following the body maintaining a suitable relationship thereto despite the driving operation has not been executed for stopping the vehicle.

18. The vehicle driving assisting apparatus according to claim 17, wherein:
the travel determining means detects at least any one of an amount of change in the distance up to the preceding vehicle existing in front of the vehicle for every predetermined period of time, an amount of change in the speed relative to the preceding vehicle for every predetermined period of time, and a turn on of a brake lamp of the preceding vehicle, and determines that the vehicle is following the preceding vehicle maintaining the suitable relationship thereto when the driving operation for decelerating the vehicle is detected by the driving condition detecting means after the amount of change in at least either a inter-vehicle distance or a relative speed within a predetermined period of time is smaller than a predetermined amount of change, or after the turn on of the brake lamp of the preceding vehicle is detected.

19. The vehicle driving assisting apparatus according to claim 15, wherein the body detecting means detects, as the body to be detected, at least any one of a preceding vehicle existing in front of the vehicle, a body which is halting, a road sign designating a step, a point where the road sign is installed designating a stop, or a point where a signal turning red sign on is installed.

20. The vehicle driving assisting apparatus according to claim 15, wherein the driving operation determining means determines that the driver of the vehicle is not executing the driving operation for stopping the vehicle short of the stopping point, when a detection result of the driving condition detecting means at least either an operation toward acceleration by the accelerator or without the braking operation.

21. A vehicle driving assisting apparatus comprising:
memory means for storing a position where at least one road facility of a traffic signal or a road sign including a stop sign is installed on a road in front of a vehicle;
imaging means for picturing an image inclusive of the road in front of the vehicle;
distance determining means for determining whether a relation of a distance between the vehicle and the road facility satisfies a predetermined condition;
detecting means for detecting the position in the image pictured by the imaging means, of the road facility determined by the distance determining means to be satisfying a predetermined condition;
gazing point detecting means for detecting a gazing point of a driver of the vehicle;
central viewing area setting means for setting, on the image, a central viewing area based on the gazing point detected by the gazing point detecting means; and
recognizing degree determining means for determining a driver's degree of recognizing the road facility depending upon whether the road facility detected by the detecting means is positioned in the central viewing area on the image set by the central viewing area setting means.

22. The vehicle driving assisting apparatus according to claim 21, wherein:
the distance determining means includes distance calculation means for calculating a distance from the vehicle up to the road facility, and determines whether the distance up to the road facility is a distance that can be viewed by the driver and, further, is a distance included in the central viewing area based on the gazing point of when the driver of the vehicle is gazing a distance of the road; and
the detecting means detects the position, in the image, of the road facility of a distance that is determined by the distance determining means to be visible by the driver and is included in the central viewing area.

23. The vehicle driving assisting apparatus according to claim 22, further comprising:
speed detecting means for detecting a speed of the vehicle,
wherein the distance determining means includes distance-varying means for varying the distance included in the central viewing area depending upon the speed detected by the speed detecting means.

24. The vehicle driving assisting apparatus according to claim 21, wherein the recognizing degree determining means determines that the driver is little recognizing the road facility when the road facility detected by the detecting means does not exist in the central viewing area on the image.

25. The vehicle driving assisting apparatus according to claim 24, further comprising:
alarm means for causing driver's attention when the recognizing degree determining means determines that the driver is little recognizing the road facility.

26. The vehicle driving assisting apparatus according to claim 25, wherein the alarm means includes alarm timing-varying means for varying timing of starting the alarm depending upon the length of the road facility outside the central viewing area in the image from the boundary of the central viewing area in the image.

27. The vehicle driving assisting apparatus according to claim 24, further comprising:
travel limiting means for imposing limitation on traveling of the vehicle when the driver is little recognizing the road facility.

28. The vehicle driving assisting apparatus according to claim 27, wherein the travel limiting means includes travel limiting timing-varying means for varying the timing for imposing limitation on the traveling depending upon the length of the road facility outside the central viewing area in the image from the boundary of the central viewing area in the image.

29. The vehicle driving assisting apparatus according to claim 27, wherein the travel limiting means limits an accelerator of the vehicle from being operated toward an accelerating side.

30. The vehicle driving assisting apparatus according to claim 27, wherein the travel limiting means drives a braking apparatus of the vehicle.
